(19) United States
(12) Patent Application Publication
(10) Pub. No.: US 2007/0294153 A1
(43) Pub. Date: Dec. 20, 2007

(54) System and method for automatically generating shipping manifests

(75) Inventors: Lynn Ann DeRose, Gloversville, NY (US); Roman Brusilovsky, Clifton Park, NY (US); Daniel John Messier, Troy, NY (US); Joseph James Salvo, Schenectady, NY (US); Brandon Stephen Good, Brainard, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/438,037

(22) Filed: May 22, 2006

(51) Int. Cl. G06Q 10/00

(52) U.S. Cl. 705/29

(57) ABSTRACT

A system for generating a shipping manifest for one or more pieces of equipment is provided. The system includes a database configured to store data representative of information located on tags related to one or more pieces of equipment to be shipped and a reader-writer component configured to read/write the data. The system further includes a shipment component. The shipment component is configured to automatically generate a shipping manifest related to the one or more pieces of equipment based on the data read by the reader-writer component and one or more business rules associated with the one or more pieces of equipment.

### BACKGROUND

The invention relates generally to asset tracking and more particularly to a method and system for automatically generating shipping manifests using wireless identification of equipment assets.

A shipping manifest generally includes information about the shipment of equipment assets from one location to another. Traditionally the generation and delivery of shipping manifests is performed manually. A shipping notice is generated in a warehouse and hand delivered by one person to another person who determines the business rules associated with the delivery of the shipping manifest to a particular “ship to” location. These business rules are generally not located in a single location or in one database, thereby causing delays in information generation. In addition, manual generation of shipping manifests results in human error and often includes “guess estimates” on equipment values and equipment depreciation rates.

It is therefore desirable to develop a system and method that enables the compilation of the data and the business rules associated with the shipment of equipment assets, in a single location. In addition, it is desirable to develop a system and method for automatically generating shipping manifests using wireless identification of equipment assets.

### BRIEF DESCRIPTION

Embodiments of the invention provide a system for generating a shipping manifest for one or more pieces of equipment. The system includes a database configured to store data representative of information located on tags related to one or more pieces of equipment to be shipped and a reader-writer component configured to read/write the data. The system further includes a shipment component. The shipment component is configured to automatically generate a shipping manifest related to the one or more pieces of equipment based on the data read by the reader-writer component and one or more business rules associated with the one or more pieces of equipment.

Other embodiments of the invention provide a system for generating a shipping manifest for one or more pieces of equipment. The system includes a database configured to store data representative of information located on tags related to one or more pieces of equipment to be shipped, a reader-writer component configured to read/write the data, and a shipment component configured to automatically generate a shipping manifest related to the one or more pieces of equipment based on the data read by the reader-writer component and one or more business rules associated with the one or more pieces of equipment. The tags include identification information related to one or more assets associated with the one or more pieces of equipment, whereas the one or more business rules include shipping criteria associated with the shipment of the one or more pieces of equipment. The shipment component is configured for connection to the database for the performance of a verification of the data read by the reader-writer component. The database is configured to store data related to a location of the one or more pieces of equipment to be shipped and related to the one or more business rules associated with the one or more pieces of equipment.

In other embodiments, a method for generating a shipping manifest for one or more pieces of equipment is provided. The method includes reading/writing data on a plurality of tags related to one or more pieces of equipment to be shipped. The method then includes automatically generating a shipping manifest related to the one or more pieces of equipment based on the data and one or more business rules associated with the one or more pieces of equipment

These and other features, aspects, and advantages of the invention will become better understood when the following detailed description is read with reference to the accompanying drawings in which like characters represent like parts throughout the drawings.

### DRAWINGS

FIG. 1 is a high-level system for automatically generating a shipping manifest for one or more pieces of equipment in accordance with embodiments of the invention.

FIG. 2 is a perspective view of an exemplary reader-writer component shown in FIG. 1.

FIG. 3 illustrates a process for generating a shipping manifest for one or more pieces of equipment in accordance with embodiments of the invention.

FIGS. 4-6 are screen views illustrating the creation of shipping asset manifests in accordance with embodiments of the invention.

FIG. 7 illustrates a shipping manifest created in accordance with embodiments of the invention.

### DETAILED DESCRIPTION OF PREFERRED EMBODIMENTS

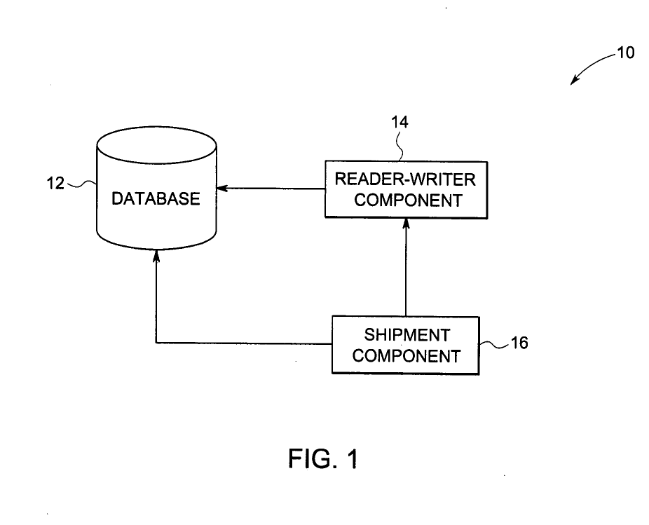

FIG. 1 is a high-level system 10 for automatically generating a shipping manifest for one or more pieces of equipment in accordance with embodiments of the invention. The system 10 includes a database 12, a reader-writer component 14, and a shipment component 16. The database 12 stores data representative of information located on tags related to one or more pieces of equipment to be shipped. The tags represent identification information related to one or more assets associated with the one or more pieces of equipment.

In one embodiment, the database 12 is configured to store data related to the location of the pieces of equipment to be shipped and data related to a plurality of business rules associated with the pieces of equipment. As used herein, the “business rules” refer to a plurality of rules related to the shipment of certain types of equipment into a particular country, the custom tariffs and depreciation rates that apply to the shipment of certain types of equipment into a particular country, and the class of the equipment being shipped. For example, for the shipment of hazardous material, a business rule may include informing relevant personnel responsible for the shipment of such hazardous material beforehand. The business rules may also represent shipping criteria associated with the shipment of the pieces of equipment. The shipping criteria may include an equipment value, an equipment depreciated value, an equipment tariff value, and an equipment custom rule associated with each piece of equipment being shipped.

The reader-writer component 14 is configured to read the data located on the tags related to the pieces of equipment being shipped. In certain embodiments, the reader-writer component 14 may also be configured to write the data back onto the tags for data storage purposes. In one embodiment, a transponder may be used to write data back onto the tags. The information from the transponder may be used to inform field engineers or warehouse personnel of critical information that they may need to know in the field. This may include information regarding gage calibration, preventative maintenance, pending warranty dates or special handling by cargo. This information enables a field engineer to be compliant and assures the quality of the gage.

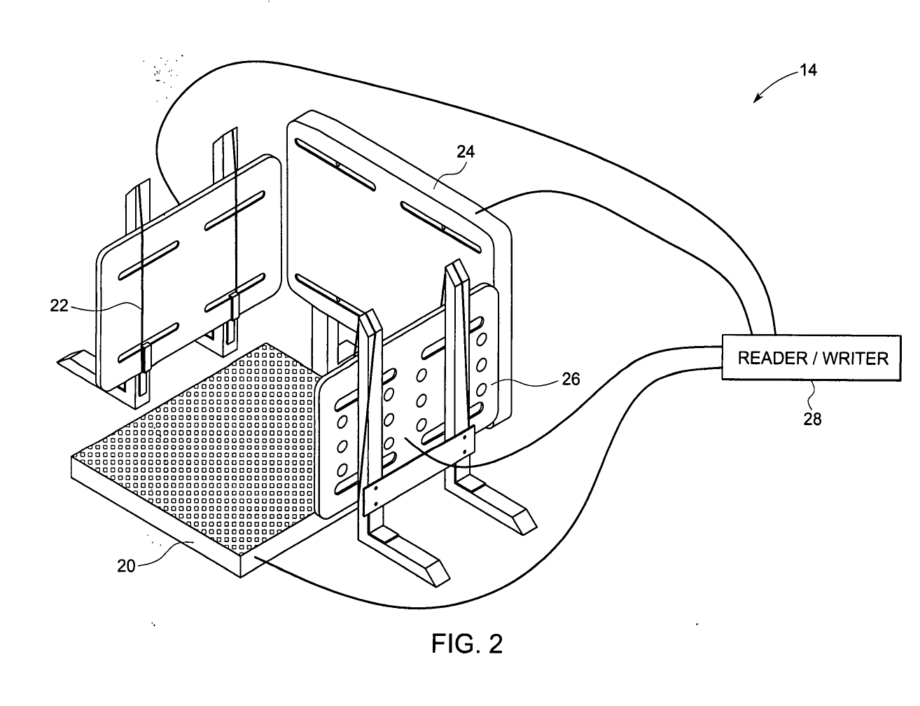

Referring to FIG. 1, the reader-writer component 14 is configured to digitally read and/or write the identification information on the tags related to the assets associated with the each piece of equipment. A scale (not shown in FIG. 1) weighs each piece of equipment and uploads information to the reader-writer component 14 on each piece of equipment being shipped. The reader-writer component 14 may use standard RFID technology to read and/or write the information on the tags. As will be appreciated by those skilled in the art, RFID technology is generally based on storing and remotely retrieving data using devices called RFID tags or transponders. Typically, an RFID tag is a small object that may be attached to or incorporated into a product, animal or person. As will be described in greater detail with reference to FIG. 2, an RFID tag contains receivers and antennas to enable them to receive and respond to radio-frequency signals from an RFID receiver. In accordance with one embodiment, the reader-writer component 14 digitally reads the RFID tags located on each piece of equipment and remotely tracks and automatically updates the number of assets being shipped with the asset information stored in the database 12.

The shipment component 16 automatically generates a shipping manifest that includes each piece of equipment being shipped based on the data read by the reader-writer component 14 and the business rules associated with the pieces of equipment. In one embodiment, the shipping manifest for each piece of equipment includes an equipment value, an equipment depreciated value, an equipment tariff value, and one or more custom rules associated with the one or more pieces of equipment. In certain embodiments, the generated shipping manifest may also be written back onto the tags to be read at remote locations, if necessary.

In certain embodiments, the shipment component 16 further performs a verification of the data read by the reader-writer component 14 by connecting to the database 12. The verification includes tracking asset information for each piece of equipment being shipped with the information stored in the database 12. The shipment component 16 may then assign an operational status of “assigned”, “packed”, “ready to ship”, “shipped”, “in transport”, “delivered” or “verified”, for each piece of equipment being shipped based on the verification. The shipment component 16 may further generate a notification of shipment of each piece of equipment being shipped upon receipt of the equipment. The notification may include the point of origin, the destination, the route, the consignor and the consignee.

FIG. 2 is a perspective view of an exemplary reader-writer component shown in FIG. 1. As shown in FIG. 2, the reader-writer component 14 may include a reader/writer 28 and one or more antennas 20, 22, 24 and 26. Tag information is stored in the database 12. The antennas 20, 22, 24 and 26 transmit a radio signal to the RFID tag. The RFID tag absorbs some of the RF energy from the radio signal and reflects the energy back as a signal containing the RFID tag information. The antennas 20, 22, 24 and 26 are configured to digitally read/write the RFID tags in three dimensions, for example along the X, Y and Z planes.

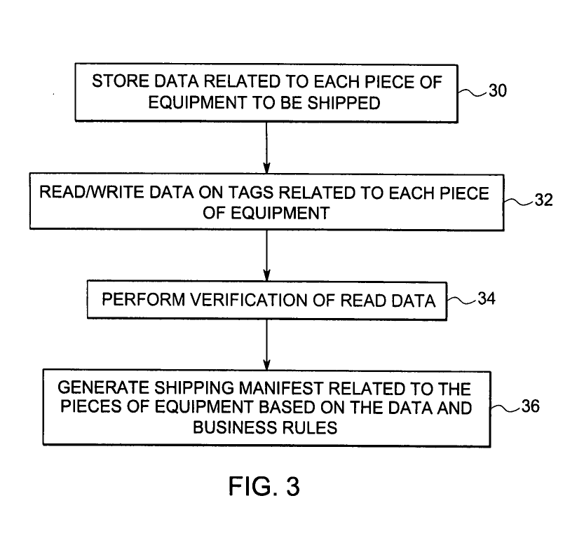

FIG. 3 illustrates a process for generating a shipping [symbol] more pieces of equipment in accordance with embodiments of the 30, the data related to each piece of equipment to be shipped embodiment, a location of each piece of equipment to be shipped business rules associated with the pieces of equipment is stored. include shipping criteria associated with the shipment of each [symbol] Also, the shipping criteria may include a plurality of rules related value, an equipment depreciated value, an equipment tariff value, custom rule associated with the one or more pieces of equipment. [symbol] on the tags related to each piece of equipment is read. As mention may also be written back onto the tags for data storage [symbol] previously, the tags include identification information related to [symbol] associated with the pieces of equipment. In step 34, a verification performed. As mentioned above, the verification includes tracking for each piece of equipment being shipped with the stored data. In [symbol] manifest that includes the pieces of equipment being shipped generated based on the data and one or more business rules associated more pieces of equipment. The shipping manifest includes an [symbol] equipment depreciated value, an equipment tariff value, and one or associated with the one or more pieces of equipment.

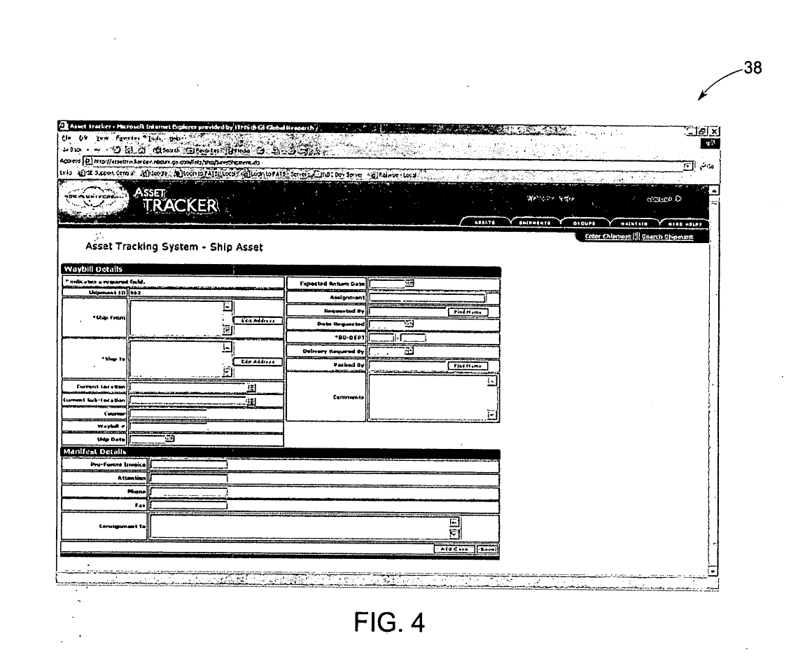

FIGS. 4-6 are screen views illustrating the creation of shipping in accordance with embodiments of the invention. The screen [symbol] Personal Computer (PC) or Macintosh screen, a terminal screen [symbol] non-networked environment, a handheld screen, or a touch screen illustration of a screen view 38 for permitting a user to enter one details related to one or more pieces of equipment being shipped. [symbol] view 38, the shipment details may generally include a shipment ID “ship to” location and shipment manifest information associated [symbol] the one or more pieces of equipment.

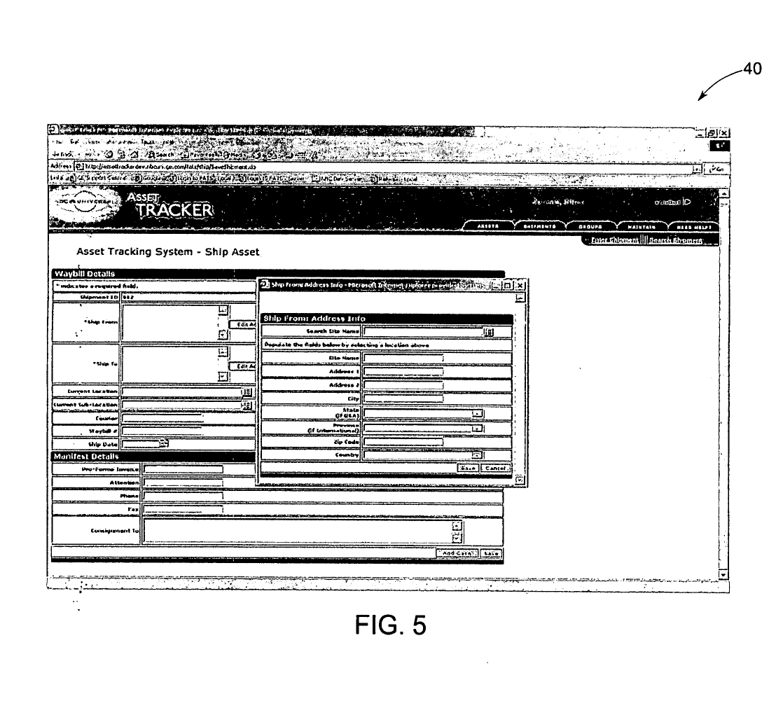

FIG. 5 is a screen view 40 illustrating an address book for [symbol] store and extract shipping addresses related to the shipment of one equipment. As illustrated in screen 40, the shipping address may include the site name and address information related to the shipment of the one or more pieces of equipment.

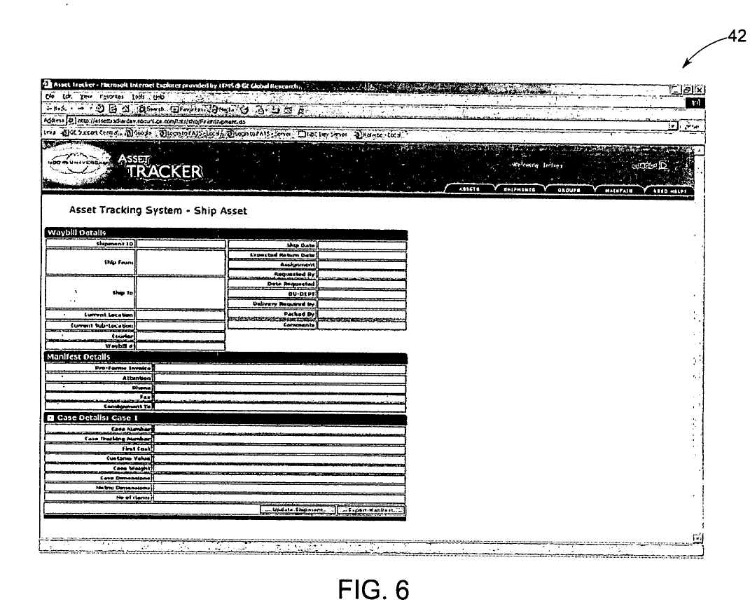

FIG. 6 is a screen view 42 illustrating case information related to the shipment of each piece of equipment. As used herein, a “case” refers to a piece of equipment and its associated assets. The case information may include a case number, a case tracking number, a cost, a customs value, a case weight, case dimensions, metric dimensions and number of items in each case. As may also be observed from the “customs value” field in screen view 42, the equipment asset values may be converted to other currencies based on the particular custom rules associated with the shipment of the equipment and its associated assets into a particular country.

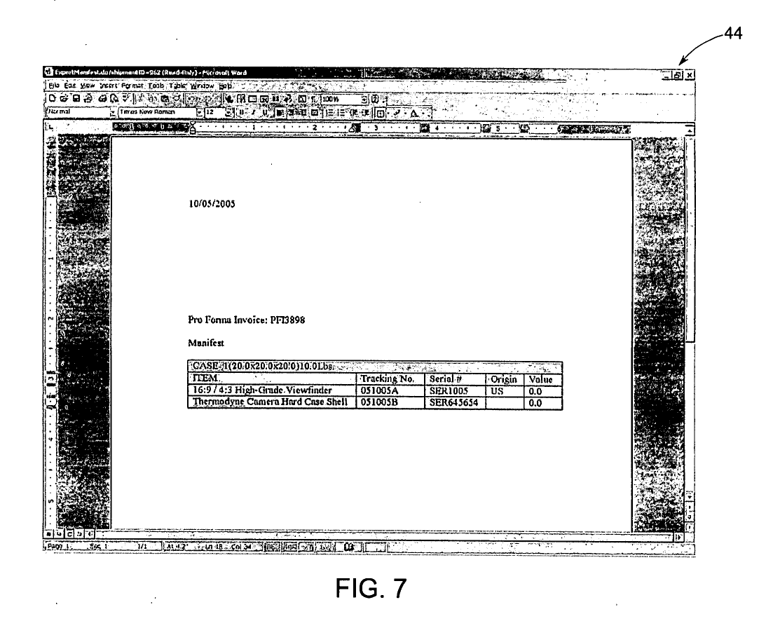

FIG. 7 illustrates a shipping manifest 44 created in accordance with embodiments of the invention. The shipping manifest 44 generally includes a tracking number, a serial number, the origin and the value of each equipment asset being shipped.

The illustrated embodiments disclose a system and method for automatically generating shipping manifests using wireless identification of equipment assets. Wireless identification devices or tags are placed on each piece of equipment. The tags are used to remotely track and automatically update the equipment being shipped. As each piece of equipment and its associated assets are packed for shipping, they are read into a shipping notice. A shipping manifest is generated based on a particular “ship to” location and a plurality of business rules for each shipping destination. The business rules generated for each country are automatically pre-populated to eliminate human error and improve information processing.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A system for generating a shipping manifest for one or more pieces of: equipment, the system comprising:
a database configured to store data representative of information located on tags related to one or more pieces of equipment to be shipped;
a reader-writer component configured to read the data; and
a shipment component configured to automatically generate a shipping manifest related to the one or more pieces of equipment based on the data read by the reader-writer component and one or more business rules associated with the one or more pieces of equipment.

2. The system of claim 1, wherein the tags comprise identification information related to one or more assets associated with the one or more pieces of equipment.

3. The system of claim 2; wherein the reader-writer component is configured to digitally read or write the identification information related to the one or more assets associated with the one or more pieces of equipment.

4. The system of claim 1, wherein the database is further configured to store data related to a location of the one or more pieces of equipment to be shipped and related to the one or more business rules associated with the one or more pieces of equipment.

5. The system of claim 1, wherein the one or more business rules comprise shipping criteria associated with the shipment of the one or more pieces of equipment.

6. The system of claim 5, wherein the shipping criteria comprise a plurality of rules related to the country of shipment and a location of shipment of the one or more pieces of equipment.

7. The system of claim 5, wherein the shipping criteria comprise a plurality of rules related to at least one of an equipment value, an equipment depreciated value, an equipment tariff value, and an equipment custom rule associated with the one or more pieces of equipment.

8. The system of claim 1, wherein the shipment component is configured to be connected to the database for the performance of a verification of the data read by the reader-writer component.

9. The system of claim 8, wherein the shipment component generates a shipping manifest for the one or more pieces of equipment based on the verification.

10. The system of claim 9, wherein the shipping manifest for the one or more pieces of equipment comprises an equipment value, an equipment depreciated value, an equipment tariff value, and one or more custom rules associated with the one or more pieces of equipment.

11. A system for generating a shipping manifest for one or more pieces of equipment, the system comprising:
a database configured to store data representative of information located on tags related to one or more pieces of equipment to be shipped, said tags comprising identification information related to one or more assets associated with the one or more pieces of equipment;
a reader-writer component configured to read the data; and
a shipment component configured to automatically generate a shipping manifest related to the one or more pieces of equipment based on the data read by the reader-writer component and one or more business rules associated with the one or more pieces of equipment, said one or more business rules comprising shipping criteria associated with the shipment of the one or more pieces of equipment and said shipment component being configured for connection to the database for the performance of a verification of the data read by the reader-writer component;
wherein the database is configured to store data related to a location of the one or more pieces of equipment to be shipped and related to the one or more business rules associated with the one or more pieces of equipment.

12. A method for generating a shipping manifest for one or more pieces of equipment, the method comprising:
reading data on a plurality of tags related to one or more pieces of equipment to be shipped; and
automatically generating a shipping manifest related to the one or more pieces of equipment based on the data and one or more business rules associated with the one or more pieces of equipment.

13. The method of claim 12, wherein said reading data comprises reading identification information related to one or more assets associated with the one or more pieces of equipment.

14. The method of claim 12, comprising storing the data related to the one or more pieces of equipment to be shipped.

15. The method of claim 12, comprising storing a location of the one or more pieces of equipment to be shipped and storing the one or more business rules associated with the one or more pieces of equipment.

16. The method of claim 12, wherein the business rules comprise shipping criteria associated with the shipment of the one or more pieces of equipment.

17. The method of claim 16, wherein the shipping criteria comprise a plurality of rules related to the country of shipment and a location of shipment of the one or more pieces of equipment.

18. The method of claim 16, wherein the shipping criteria comprise a plurality of rules related to at least one of an equipment value, an equipment depreciated value, an equipment tariff value, and an equipment custom rule associated with the one or more pieces of equipment.

19. The method of claim 12, further comprising performing a verification of the data read prior to generating a shipping manifest related to the one or more pieces of equipment.

20. The method of claim 19, wherein the shipping manifest related to the one or more pieces of equipment comprises an equipment value, an equipment depreciated value, an equipment tariff value, and one or more custom rules associated with the one or more pieces of equipment.
